(19) United States
(12) Patent Application Publication
(10) Pub. No.: US 2013/0224416 A1
(43) Pub. Date: Aug. 29, 2013

(54) SILICONE ADHESIVE COMPOSITION FOR A WINDOW FILM HAVING EXCELLENT RELEASE PROPERTIES AND COMPATIBILITY, AND WINDOW FILM USING SAME

(71) Applicants: Ik-Hwan Cho, Daejeon (KR); Tae-Hwa Lee, Daejeon (KR)

(72) Inventors: Ik-Hwan Cho, Daejeon (KR); Tae-Hwa Lee, Daejeon (KR)

(73) Assignee: LG HAUSYS, LTD., Seoul (KR)

(21) Appl. No.: 13/884,462

(22) PCT Filed: Nov. 7, 2011
(86) PCT No.: PCT/KR2011/008422

§ 371 Date: May 9, 2013

(30) Foreign Application Priority Data
Nov. 10, 2010 (KR) 10-2010-0111498

(51) Int. Cl. C09J 183/06; C09J 7/02

(52) U.S. Cl. CPC C09J 183/06; C09J 7/0225
USPC 428/40.9; 525/478

(57) ABSTRACT

Provided are a silicone adhesive composition for a window film, and a window film using same, wherein the composition has excellent release properties for easy release from a window, and also has excellent compatibility with a UV absorbent. The silicone adhesive composition for a window film, according to the present invention, is characterized by comprising: a) 100 parts by weight of a combination of a silicone adhesive and a silicone release agent; b) 1 to 10 parts by weight of a crosslinking agent; c) 0.1 to 2 parts by weight of a platinum based catalyst; and d) 0.1 to 5 parts by weight of an anchoring agent, wherein the weight ratio of the silicone adhesive to the silicone release agent is in the range of 1:1 to 1:0.2.

### TECHNICAL FIELD

The present invention relates to an adhesive composition for a window film, and more particularly, to an adhesive composition for a window film, which exhibits excellent durability and weatherproofing capabilities as well as excellent compatibility with a UV absorbent to avoid defective delamination due to crystallization while providing excellent repeelability, when applied to a window as an adherend, and a window film using the same.

### BACKGROUND ART

Generally, an opening for buildings, vehicles or displays includes a transparent glass or resin plate for transmittance of sunlight. However, sunlight includes ultraviolet light or near infrared light in addition to visible light.

Ultraviolet light contained in sunlight causes sunburns and has negative effects on human health. Further, it is well-known that the content of a container spoils as a result of deterioration of a packing material by ultraviolet light.

In the meantime, near infrared light contained in sunlight increases the indoor temperature upon direct illumination, thereby causing a problem such as reduction in cooling effects in summer

Thus, in order to avoid such problems, a window film such as a light shield film for shielding ultraviolet light or near infrared light is used for attachment to a glass window for buildings or vehicles. Such a window film is attached to the window of buildings or vehicles via an adhesive. However, for conventional adhesives for a window film, it is difficult to block ultraviolet light by 95% or more when applied to a thickness of 10 nm or less.

Further, such an adhesive composition has poor compatibility with a solid UV absorbent, causing a problem such as defective delamination due to crystallization or migration of the UV absorbent toward the surface of the film.

Due to such poor compatibility, the conventional adhesive composition generally contains a liquefied UV absorbent. However, such a liquefied UV absorbent can cause problems such as high manufacturing costs and low durability.

Further, the conventional adhesive composition has poor weatherproofing capabilities causing deformation under high temperature and high humidity conditions.

Moreover, when exposed to sunlight for a long period of time, the conventional adhesive composition increases in adhesive force with a window and thus leaves waste residue upon removal from the window, thereby making it difficult to separate the adhesive composition therefrom.

### DISCLOSURE

### Technical Problem

An aspect of the present invention is to provide a silicone adhesive composition for a window film, which has excellent repeelability, facilitating removal from glass to which the adhesive composition is attached, while ensuring excellent compatibility with a UV absorbent.

Another aspect of the present invention is to provide a window film formed of the silicone adhesive composition to provide excellent UV absorption and repeelability.

### Technical Solution

In accordance with one aspect of the present invention, a silicone adhesive composition for a window film includes: a) 100 parts by weight of a combination of a silicone adhesive and a silicone release agent; b) 1 to 10 parts by weight of a crosslinking agent; c) 0.1 to 2 parts by weight of a platinum based catalyst; and d) 0.1 to 5 parts by weight of an anchoring agent, wherein the weight ratio of the silicone adhesive to the silicone release agent ranges from 1:1 to 1:0.2.

In accordance with another aspect of the present invention, a window film includes: a base layer; an adhesive layer on the base layer, the adhesive layer being composed of a silicone adhesive composition and a UV absorbent added thereto; and a release film for protecting the adhesive layer.

### Advantageous Effects

The silicone adhesive composition for a window film according to the present invention has advantages in that it can be easily removed from an adherend and leaves less waste residue when removed, thereby providing excellent repeelability.

Further, the silicone adhesive composition for a window film according to the present invention has advantages in that it has excellent compatibility with a solid UV absorbent, thereby preventing defective delamination due to crystallization or migration of the UV absorbent toward the surface of the film.

Accordingly, when an adhesive layer is formed by adding an UV absorbent to the silicon adhesive composition according to the present invention, the content of the UV absorbent in the adhesive composition can be increased, whereby even a thin adhesive layer of about 10 nm may exhibit a UV transmittance of 5% or less.

### DESCRIPTION OF DRAWINGS

FIG. 1 is a schematic sectional view of a window film to which a silicon adhesive composition according to the present invention is applied.

### MODE FOR INVENTION

The above and other aspects, features, and advantages of the present invention will become apparent from the detailed description of the following embodiments in conjunction with the accompanying drawings. It should be understood that the present invention is not limited to the following embodiments and may be embodied in different ways, and that the embodiments are given to provide complete disclosure of the present invention and thorough understanding of the present invention to those skilled in the art. The scope of the present invention is defined only by the claims. Like reference numerals indicate like elements throughout the specification.

Now, a detailed description will be given of a silicone adhesive composition having excellent repeelability and compatibility and a window film using the same with reference to the accompanying drawing.

A silicone adhesive composition for a window film according to the present invention includes a) 100 parts by weight of a silicone adhesive, b) 1 to 10 parts by weight of a crosslinking agent, c) 0.1 to 2 parts by weight of a platinum based catalyst, and d) 0.1 to 5 parts by weight of an anchoring agent.

a) Silicone Adhesive and Silicone Release Agent

In the present invention, the silicone adhesive may be a poly dimethyl siloxane (PDMS) adhesive.

One example of commercially available products of the poly dimethyl siloxane adhesive may include 7657 (Dow Corning Company).

The silicone release agent serves to regulate peel strength of the silicone adhesive composition according to the present invention. The silicone adhesive composition has excellent weather-proofing ability, durability and waterproofing capabilities, thereby enabling semi-permanent use thereof.

However, when there is a need for removal of a window film, to which a silicone adhesive composition is applied, according to actual environment and application, a conventional silicone adhesive composition leaves much waste residue, which is unlikely to be peeled off. The silicone release agent prevents such a problem of the conventional silicone adhesive composition, thereby enabling adjustment of peel strength.

Such a releasing agent may employ vinyl group-containing silicone gum, such as 7226 (Dow Corning Company). This resin contains a small amount of an ˜O—Si—H crosslinking agent.

Here, the ratio of the silicone adhesive to the silicone release agent preferably ranges from 1:1 to 1:0.2. If the ratio of the silicone release agent to the silicone adhesive exceeds 100% in terms of weight, the composition exhibits reduced peel strength, and if the ratio of the silicone release agent the silicone adhesive is less than 20% in terms of weight, the composition is deteriorated in terms of repeelability.

b) Crosslinking Agent

The crosslinking agent may employ an organic silicone compound having a SiH functional group. One example of commercially available products of the crosslinking agent is 7367 (Dow Corning Company).

The crosslinking agent may be present in an amount of 1 to 10 parts by weight based on 100 parts by weight of the silicone adhesive. If the content of the crosslinking agent is less than 1 part by weight based on 100 parts by weight of the silicone adhesive, it is difficult to secure sufficient crosslinking density. If the content of the crosslinking agent exceeds 10 parts by weight based on 100 parts by weight of the silicone adhesive, hardness of the adhesive composition excessively increases due to excessive crosslinking, thereby reducing initial adhesive strength and peel strength.

c) Platinum Based Catalyst

The platinum based catalyst functions to adjust crosslinking density.

Such a platinum based catalyst may include platinum (Pt), ruthenium (Ru), osmium (Os), or alloys of at least one of these elements, such as Pt—Ru, Pt—Pd, Pt—Ti, and the like. Such a platinum based catalyst may be used alone or in combination thereof.

The platinum based catalyst may be present in an amount of 0.1 to 2 parts by weight based on 100 parts by weight of the silicone adhesive. If the content of the platinum based catalyst is less than 0.1 parts by weight based on 100 parts by weight of the silicone adhesive, there are problems such as low curing rate. Further, if the content of the platinum based catalyst exceeds 2 parts by weight based on 100 parts by weight of the silicone adhesive, there is a problem in that curing hardly occurs.

d) Anchoring Agent

The anchoring agent functions to increase adhesive strength of the silicone adhesive.

The anchoring agent may be a silane coupling agent or a mixture of the silane coupling agent and PDMS, and a commercialized example thereof is 9250 (Dow Corning Company).

The anchoring agent may be present in an amount of 0.1 to 5 parts by weight based on 100 parts by weight of the silicone adhesive. If the content of the anchoring agent is less than 0.1 part by weight based on 100 parts by weight of the silicone adhesive, the adding effect is low. Further, if the content of the anchoring agent exceeds 5 parts by weight based on 100 parts by weight of the silicone adhesive, the composition undergoes significant reduction in peel strength and initial adhesive strength.

According to the present invention, the adhesive composition may have a crosslinking density of 50% or more. If the crosslinking density is less than 50%, the composition can be deteriorated in durability under high temperature and high humidity conditions, thereby making it difficult to secure long-term durability and dimensional stability.

According to the present invention, the adhesive composition may have a molecular weight (Mw) of 600,000 or more for a main resin formed by crosslinking. If the main resin molecular weight of the adhesive composition is less than 600,000, the adhesive composition can leave waste residue due to insufficient cohesion of polymers upon removal thereof, or can be deteriorated in terms of durability. If the main resin molecular weight (Mw) of the adhesive composition exceeds 1,500,000, weatherproofing capabilities of the adhesive composition can be significantly reduced irrespective of increase in cohesion of the polymer.

According to the present invention, as a result of test, the adhesive composition has a peel strength value of at least 40 g/25 mm. If the peel strength of the adhesive composition for a window film is less than 20 g, the window film can be released even by slight impact. Thus, the peel strength of the adhesive composition may be 35 g/25 mm or more to secure durability and application stability.

Now, characteristics of the silicon adhesive composition according to the present invention will be described with reference to examples, and it should be understood that the following examples are provided for illustration only and are not to be construed in any way as limiting the present invention.

Descriptions of details apparent to those skilled in the art will be omitted herein.

1. Preparation of Adhesive Composition

### EXAMPLE 1

2 g of a crosslinking agent 7367 (Dow Corning Company), 1 g of a platinum catalyst, and 2 g of an anchoring agent 9250 (Dow Corning Company) were added to 50 g of a silicone adhesive 7657 (Dow Corning Company) and 50 g of a silicone release agent 7226 (Dow Corning Company), thereby preparing a silicone adhesive composition.

### EXAMPLE 2

2 g of a crosslinking agent 7367 (Dow Corning Company), 1 g of a platinum catalyst, and 2 g of an anchoring agent 9250 (Dow Corning Company) were added to 67 g of a silicone adhesive 7657 (Dow Corning Company), which contains 56.5 wt % of solid content, and 33g of a silicone release agent 7226 (Dow Corning Company), thereby preparing a silicone adhesive composition.

### EXAMPLE 3

2 g of a crosslinking agent 7367 (Dow Corning Company), 0.5 g of a platinum catalyst, and 2 g of an anchoring agent 9250 (Dow Corning Company) were added to 83 g of a silicone adhesive 7657 (Dow Corning Company) and 17 g of a silicone release agent 7226 (Dow Corning Company), thereby preparing a silicone adhesive composition.

### COMPARATIVE EXAMPLE 1

2 g of a crosslinking agent 7367 (Dow Corning Company), 0.5 g of a platinum catalyst, and 2 g of an anchoring agent 9250 (Dow Corning Company) were added to 91 g of a silicone adhesive 7657 (Dow Corning Company) and 9 g of a silicone release agent 7226 (Dow Corning Company), thereby preparing a silicone adhesive composition.

### COMPARATIVE EXAMPLE 2

2 g crosslinking agent 7367 (Dow Corning Company), 0.5 g of a platinum catalyst, and 2 g of an anchoring agent 9250 (Dow Corning Company) were added to 45 g of a silicone adhesive 7657 (Dow Corning Company) and 55 g of a silicone release agent 7226 (Dow Corning Company), thereby preparing a silicone adhesive composition.

### COMPARATIVE EXAMPLE 3

2 g of a crosslinking agent 7367 (Dow Corning Company), 0.5 g of a platinum catalyst, and 2 g of an anchoring agent 9250 (Dow Corning Company) were added to 100 g of a silicone adhesive 7657 (Dow Corning Company), thereby preparing a silicone adhesive composition.

### COMPARATIVE EXAMPLE 4

An acryl adhesive composition having a molecular weight (Mw) of 1,500,000 and comprising 10 wt % of acryl acid, 2.5 wt % of a hydroxyl monomer, and 3.5 wt % of an isocyanate crosslinking agent was prepared.

2. Evaluation of Physical Properties

a) Evaluation of 180° Peel Strength

Each of films prepared using the adhesive compositions prepared in the inventive examples and the comparative examples was attached to a UV-curable paint coated sheet using a 2 kg roller according to JIS Z 0237 to prepare a specimen, which in turn was held for 24 hours under conditions of 23° C. and 55% RH and then held in a 60° C. oven for 5 days, followed by measurement of peel strength in g/25 mm by peeling the film from the sheet at a peeling rate of 0.3 m/min using a tensile tester. The specimen was prepared by cutting the sheet-film assembly into 2.5 cm×20 cm pieces.

Test conditions were ‘holding under room temperature for 1 day’ ((a) in Table 1), and ‘holding under room temperature for 1 hour after holding at 200° C. for 1 hour’ ((b) in Table 1).

b) Evaluation of Durability

Each of samples was held in a 150° C. oven for 1 hour and then was evaluated as to bubble generation. Further, the samples were held in a 5° C. refrigerator for 10 days and then were evaluated as to crystallization and bubble generation.

2. Evaluation Results of Physical Properties

Table 1 shows evaluation results on physical properties of the films prepared in Examples 1 to 3 and Comparative Examples 1 to 3.

TABLE 1

| | | | | | | Durability | |
|---|---|---|---|---|---|---|---|
| | Peel Strength | | | | | High | Low |
| | (g/25 mm) | | Waste | | | Temp. | Temp. |
| Kind | (a) | (b) | Residue | Bubble | Crystallization | (150° C.) | (5° C.) |
| Example 1 | 40 | 50 | X | X | X | ◯ | ◯ |
| Example 2 | 170 | 200 | X | X | X | ◯ | ◯ |
| Example 3 | 800 | 1010 | X | X | X | ◯ | ◯ |
| Comparative | 1600 | 2100 | X | X | X | ◯ | ◯ |
| Example 1 | | | | | | | |
| Comparative | 10 | 12 | X | X | X | ◯ | ◯ |
| Example 2 | | | | | | | |
| Comparative | 2500 | 3500 | ◯ | X | X | ◯ | ◯ |
| Example 3 | | | | | | | |
| Comparative | 130 | 150 | ◯ | ◯ | ◯ | ◯ | ◯ |
| Example 4 | | | | | | | |

Referring to Table 1, the films prepared using the silicone adhesive compositions of Examples 1 to 3 showed lower peel strength (g/25 mm) than the films of Comparative Examples 1 and 3, and no waste residue, thereby providing excellent repeelability. The film of Comparative Example 2 has a peel strength value of less than 20 g/25 mm and was peeled off even by slight impact.

Further, the films prepared using the silicone adhesive compositions of Examples 1 to 3 provided no waste residue and no crystallization. This means that the silicone adhesive composition according to the present invention has excellent compatibility with UV absorbents. On the contrary, the film of Comparative Example 4 underwent bubble generation and crystallization, thereby exhibiting low compatibility with the UV absorbents.

All of the films prepared in Examples 1 to 3 and Comparative Examples 1 to 4 showed good durability at both high and low temperatures.

As such, the silicone adhesive composition for a window film according to the present invention has excellent compatibility with a UV absorbent and good durability at both high and low temperatures.

In the case of a conventional acryl adhesive, if a UV absorbent is added in an amount of 4% or more by weight thereto, appearance quality is deteriorated due to phase-segregation or crystallization. Further, under high temperature and high humidity conditions, the adhesive can exhibit poor durability due to bubbles or delamination caused by moisture, and can be deteriorated in UV-cutting ability due to moisture.

However, since the silicone adhesive composition according to the present invention has excellent weatherproofing ability, durability and waterproofing capabilities, the UV-cutting ability of a window film is not affected by moisture when the window film is prepared using the silicone adhesive composition according to the present invention.

Further, the silicone adhesive composition according to the present invention has excellent compatibility with a UV absorbent and thus may contain 4% or more by weight of a UV absorbent. Thus, even a thin adhesive layer can provide excellent UV-cutting ability.

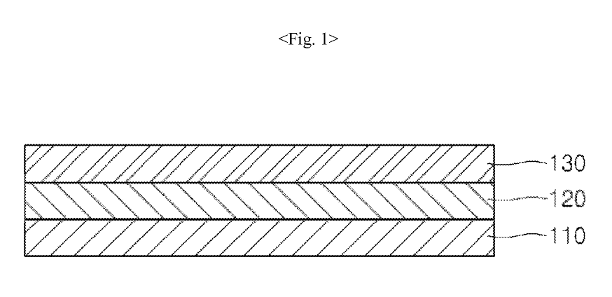

FIG. 1 schematically shows a window film to which a silicone adhesive composition according to the present invention is applied.

Referring to FIG. 1, an adhesive layer 120 prepared by adding a UV absorbent to the silicon adhesive composition according to the present invention is formed on a surface of the window film 110. The surface of the adhesive layer 120 is protected by a release film 130.

The adhesive layer may have a thickness of 8 μm to 50 μm. If the thickness is less than 8 μm, UV-cutting efficiency is reduced. Further, if the thickness exceeds 50 μm, manufacturing costs are increased, despite improvement of UV cutting ability due to increase in the content of the UV absorbent, and dust collects around the thick adhesive layer, causing contaminant stripes due to dust or foreign matter.

The window film 110 may be applied to a variety of fields such as industrial films, films for museums, light shield films, sunlight-regulation films, etc. Further, according to functional classification, the window film may be applied to protection films, cleaning sheets, reflective sheets, structural adhesive sheets, adhesive sheets for photographs, etc.

Examples of the UV absorbent contained in the adhesive layer 120 may include benzophenone based absorbents, benzotriazole based absorbents, and octylmethoxy cinnamate based absorbents, without being limited thereto.

The UV absorbent may be present in an amount of 6 wt % to 10 wt % based on the total weight of the adhesive layer, more preferably 7 wt % to 8 wt % based on the total weight of a 10 μm thick adhesive layer. If the content of the UV absorbent is less than 6 wt % base on the total weight of the adhesive layer, it is difficult to obtain a UV transmittance of 5% or less. Further, if the content of the UV absorbent exceeds 10 wt % based on the total weight of the adhesive layer, there can be degradation in physical properties of the adhesive composition, such as surface transition of the UV absorbent, due to excessive addition of the UV absorbent.

The UV absorbent may be used irrespective of phase, such as solid or liquid phase. In the case of a liquid UV absorbent, a greater amount of UV absorbent can be used at high cost.

In the case of an adhesive composition for a window film, UV-cutting efficiency is improved with increasing amount of the UV absorbent. For example, if the content of the UV absorbent is 3 wt %, the adhesive composition has a UV-cutting efficiency of 70% at a wavelength of 380 nm, and if the content of the UV absorbent is 8 wt %, the adhesive composition has a UV-cutting efficiency of approximately 97%.

However, if the content of the UV absorbent is excessively high, physical properties of the adhesive composition can be deteriorated due to crystallization or migration towards the surface of the film, surface appearance and durability of the film can also deteriorate due to the adhesive's slipping toward film edges (adhesive agglomerate). For these reasons, for a conventional acryl adhesive composition for a window film, it is difficult to add a UV absorbent in an amount of 4 wt % or more. As a result, in order to obtain high UV-cutting efficiency, the adhesive layer must be made thicker, causing increase in manufacturing costs of the adhesive composition.

However, the silicone adhesive composition according to the present invention has excellent compatibility with a UV absorbent such that the content of the UV absorbent can be substantially doubled in the adhesive composition, thereby improving UV-cutting ability while allowing formation of a thin adhesive layer.

Further, although a conventional silicone adhesive composition has excellent durability and weatherproofing ability, it is difficult to remove the adhesive composition from a window surface, to which the adhesive composition has been attached, or otherwise, in the case where it is easy to remove the adhesive composition from the window, the adhesive composition exhibits low adhesion. However, the adhesive composition according to the present invention can be easily removed therefrom, and does not leave waste residue upon removal, thereby providing excellent repeelability.

As described above, the silicone adhesive composition according to the present invention has good compatibility with a UV absorbent, thereby exhibiting no crystallization while providing excellent properties in terms of durability, weatherproofing ability and repeelability.

Thus, the window film according to the present invention may be applied to a variety of window films, particularly films for museums or high-price displays, may provide effective operation for a period of one year or less, and may suitably function for a period of over 5 years. Furthermore, based on good weatherproofing capabilities of the adhesive composition, the film may be used under severe weather conditions having a great variance in temperature and humidity.

Although some embodiments have been described herein, it will be understood by those skilled in the art that these embodiments are provided for illustration only, and various modifications, changes, alterations and equivalent embodiments can be made without departing from the scope of the present invention. Therefore, the scope and sprit of the present invention should be defined only by the accompanying claims and equivalents thereof.

1. A silicone adhesive composition for a window film, comprising: a) 100 parts by weight of a combination of a silicone adhesive and a silicone release agent; b) 1 to 10 parts by weight of a crosslinking agent; c) 0.1 to 2 parts by weight of a platinum based catalyst; and d) 0.1 to 5 parts by weight of an anchoring agent, wherein the weight ratio of the silicone adhesive to the silicone release agent ranges from 1:1 to 1:0.2.

2. The silicone adhesive composition according to claim 1, wherein the silicone adhesive comprises a poly dimethyl siloxane adhesive.

3. The silicone adhesive composition according to claim 1, wherein the silicone release agent comprises vinyl group-containing silicone gum.

4. The silicone adhesive composition according to claim 1, wherein the crosslinking agent comprises an organic silicone compound having an SiH functional group.

5. The silicone adhesive composition according to claim 1, wherein the platinum based catalyst comprises at least one selected from the group consisting of platinum (Pt), ruthenium (Ru), osmium (Os), and alloys comprising at least one of platinum (Pt), ruthenium (Ru) and osmium (Os).

6. The silicone adhesive composition according to claim 1, wherein the anchoring agent comprises a silane coupling agent, or a mixture of the silane coupling agent and poly dimethyl siloxane (PDMS).

7. The silicone adhesive composition according to claim 1, wherein the adhesive composition has a crosslinking density of 50% or more.

8. The silicone adhesive composition according to claim 1, wherein the adhesive composition has a main resin molecular weight (Mw) of 600,000 or more.

9. A window film comprising: a base layer; an adhesive layer on the base layer, the adhesive layer being composed of the silicone adhesive composition according to claim 1 and a UV absorbent added thereto; and a release film for protecting the adhesive layer.

10. The window film according to claim 9, wherein the adhesive layer comprises 6 wt % to 10 wt % of the UV absorbent.

11. The window film according to claim 9, wherein the UV absorbent comprises at least one selected from the group consisting of benzotriazole based UV absorbents, benzophenone based UV absorbents, and octylmethoxy cinnamate based UV absorbents.

12. The window film according to claim 9, wherein the adhesive layer has a thickness of 8 μm to 50 μm.
